(19) United States
(12) Patent Application Publication
(10) Pub. No.: US 2026/0202696 A1
(43) Pub. Date: Jul. 16, 2026

(54) OPTICAL DEVICE, AND OPTICAL APPARATUS

(71) Applicant: HAMAMATSU PHOTONICS K.K., Hamamatsu-shi, Shizuoka (JP)

(72) Inventors: Hiroto SAKAI, Shizuoka (JP); Tsubasa WATANABE, Shizuoka (JP); Hiroshi TANAKA, Shizuoka (JP)

(73) Assignee: HAMAMATSU PHOTONICS K.K., Hamamatsu-shi, Shizuoka (JP)

(21) Appl. No.: 19/135,457

(22) PCT Filed: Nov. 29, 2023
(86) PCT No.: PCT/JP2023/042775

§ 371 Date: Jun. 4, 2025

(30) Foreign Application Priority Data
Dec. 22, 2022 (JP) 2022-205708

(51) Int. Cl. G02F 1/03

(52) U.S. Cl. CPC G02F 1/0311

(57) ABSTRACT

This optical device comprises an electro-optical crystal body, a plurality of electric field generators, a first lens array, a light-shielding member, and a second lens array. The electro-optical crystal body receives first parallel beam on a main surface and outputs the first parallel beam from a rear surface. The plurality of electric field generators are arranged in a one-dimensional or two-dimensional array. In the electro-optical crystal body, the plurality of electric field generators each generate an electric field of an intensity that changes cyclically, and are independently capable of controlling the state of said electric field. The first lens array, in each of a plurality of first lenses, focuses the first parallel beam outputted from the electro-optical crystal body. The light-shielding member, in each of a plurality of regions, allows the focused beam to pass or blocks the same.

### TECHNICAL FIELD

The present disclosure relates to an optical device and an optical apparatus. Priority is claimed on Japanese Patent Application No. 2022-205708, filed on Dec. 22, 2022, the entire content of which is incorporated herein by reference.

### BACKGROUND ART

Patent Literatures 1 to 7 disclose optical modulators. Each of these optical modulators includes an electro-optic crystal and a plurality of electrodes that individually generate electric fields inside the electro-optic crystal. The electro-optic crystal is, for example, a Perovskite-type electro-optic crystal having a dielectric constant of 1000 or more. The electro-optical crystal is, for example, a KTN crystal, a KLTN crystal, or a PLZT crystal.

### CITATION LIST

### Patent Literature

Patent Literature 1: PCT International Publication No. WO 2017/213098
Patent Literature 2: PCT International Publication No. WO 2017/213099
Patent Literature 3: PCT International Publication No. WO 2017/213100
Patent Literature 4: PCT International Publication No. WO 2017/213101
Patent Literature 5: PCT International Publication No. WO 2019/111332
Patent Literature 6: PCT International Publication No. WO 2019/111333
Patent Literature 7: PCT International Publication No. WO 2019/111334

### SUMMARY OF INVENTION

### Technical Problem

An optical device using a crystal capable of switching the disposition pattern of parallel beam in a plane perpendicular to an optical axis at high speed and freely is useful. As one example, a combination of such an optical device and a spatial light modulator is provided. Namely, when the phase of light is spatially modulated, a spatial light modulator is used. In addition to the spatial light modulators, each including the electro-optic crystal, as described in Patent Literatures 1 to 7, there is also a spatial light modulator including a liquid crystal layer (liquid crystal spatial light modulator). In the liquid crystal spatial light modulator, an electric field is individually generated inside the liquid crystal layer by each of a plurality of electrodes. However, in the liquid crystal spatial light modulator, since the response of the liquid crystal to a change over time in the electric field inside the liquid crystal layer is delayed, accelerating the switching of modulation patterns is impaired, which is a problem. Therefore, for example, it is preferable that the modulation region of the liquid crystal spatial light modulator is divided into a plurality of regions and a parallel beam is sequentially input to each of the plurality of regions using the optical device as described above. Accordingly, the switching of the modulation patterns can be accelerated while sacrificing resolution.

An object of the present disclosure is to provide an optical device capable of switching the disposition pattern of parallel beam in a plane perpendicular to an optical axis at high speed and freely, and an optical apparatus capable of accelerating the switching a modulation pattern.

### Solution to Problem

[1] An optical device according to the present disclosure includes: an electro-optic crystal body having a plate shape; a plurality of electric field generators; a first lens array; a light shielding member; and a second lens array. The electro-optic crystal body has a main surface and a back surface, and is configured to receive a first parallel beam on the main surface and to output the first parallel beam from the back surface. The plurality of electric field generators are disposed side by side in a one-dimensional or two-dimensional manner in a plane along the main surface or the back surface of the electro-optic crystal body. The plurality of electric field generators are respectively configured to generate electric fields, a strength of which changes cyclically in a direction along the main surface or the back surface of the electro-optic crystal body, inside the electro-optic crystal body, and are configured to be able to independently control states of the electric fields. The first lens array includes a plurality of first lenses corresponding to the plurality of electric field generators, respectively, and is configured to focus the first parallel beam, which is output from the back surface of the electro-optic crystal body, using each of the plurality of first lenses. The light shielding member has a plurality of regions corresponding to the plurality of electric field generators, respectively, and is configured to allow a beam, which is focused by each of the plurality of first lenses, to pass through the light shielding member or to shield the beam in each of the plurality of regions depending on a state of an electric field of a corresponding electric field generator among the plurality of electric field generators. The second lens array includes a plurality of second lenses corresponding to the plurality of regions, respectively, and is configured to convert the beam, which has passed through the light shielding member, into a second parallel beam using each of the plurality of second lenses.

In the optical device according to [1] above, when an electric field is generated inside the electro-optic crystal body by a certain electric field generator, a periodic change in refractive index occurs instantaneously in a region inside the electro-optic crystal body corresponding to the electric field generator. When the first parallel beam passes the electro-optic crystal body where a periodic change in the refractive index occurs, the phase distribution of the first parallel beam changes. Therefore, when the first parallel beam is focused by the first lenses, the beam is focused at a plurality of focal points separated from each other. In contrast, when no electric field is generated inside the electro-optic crystal body by each of the plurality of electric field generators, no periodic change in the refractive index occurs inside the electro-optic crystal body. Even when the first parallel beam passes through such an electro-optic crystal body, no change occurs in the phase distribution of the first parallel beam. Therefore, when the first parallel beam is focused by the first lens, the beam is focused at a single focal point.

Each region of the light shielding member allows the beam, which is focused by the corresponding first lens, to pass through each region or shields the beam depending on the state of the electric field of the corresponding electric field generator. In one example, each region of the light shielding member shields the beam when the beam is focused at the plurality of focal points separated from each other, and allows the beam to pass through each region when the beam is focused at the single focal point. In another example, each region of the light shielding member allows the beam to pass through each region when the beam is focused at the plurality of focal points separated from each other, and shields the beam when the beam is focused at the single focal point. Therefore, whether a plurality of portions of the first parallel beam corresponding to the plurality of electric field generators, respectively, pass through the light shielding member can be freely determined for each portion. Of the beam focused by the first lens array, the beam that has passed through the light shielding member is converted into the second parallel beam by the corresponding second lens, and is output to the outside of the optical device. Therefore, the disposition pattern of the parallel beam in a plane perpendicular to an optical axis can be switched at high speed and freely by switching the electric field generators that generate electric fields.
[2] In the optical device according to [1] above, each of the plurality of electric field generators may include a first transparent electrode provided on the main surface and configured to transmit the first parallel beam, and a second transparent electrode provided on the back surface, and configured to transmit the first parallel beam and to cooperate with the first transparent electrode to generate the electric fields inside the electro-optic crystal body. One or both of the first transparent electrode and the second transparent electrode may include a structure that is periodic in the direction. In this case, a configuration in which the first parallel beam passes through the electro-optic crystal body while periodic electric fields are generated inside the electro-optic crystal body can be simply realized.
[3] In the optical device according to [2], one or both of the first transparent electrode and the second transparent electrode may have a comb shape. In this case, the number of connecting points between the first transparent electrode and/or the second transparent electrode including a periodic structure and wirings for applying a voltage to the transparent electrodes can be reduced. Therefore, the structure for applying a voltage to the transparent electrodes can be simplified.
[4] In the optical device according to any one of [1] to [3] above, each of the plurality of regions may be configured to allow the beam, which is focused by each of the plurality of first lenses, to pass through each of the plurality of regions when the electric field of the corresponding electric field generator among the plurality of electric field generators is in an OFF state, and to shield the beam when the electric field of the corresponding electric field generator is in an ON state. When the electric field of the electric field generator is in an ON state, a periodic refractive index distribution occurs inside the electro-optic crystal body, and the phase distribution of the first parallel beam changes. When the first parallel beam passes through the light shielding member, the phase distribution of the first parallel beam also remains in the second parallel beam. As a result, optical elements disposed downstream of the optical device are affected by the phase distribution. In contrast, when the electric field of the electric field generator is in an OFF state, the refractive index distribution inside the electro-optic crystal body does not change, and the phase distribution of the first parallel beam does not change. Therefore, by allowing the beam, which is focused by the first lens, to pass through each region when the electric field of the electric field generator is in an OFF state, the influence on the optical elements disposed downstream of the optical device can be reduced.
[5] In the optical device according to any one of [1] to [4] above, each of the plurality of first lenses may be a cylindrical lens having a refractive power mainly in the direction in which the strength of the electric fields changes cyclically. Each of the plurality of regions may include a slit extending along an extending direction of the cylindrical lens. In this case, it is sufficient to perform alignment between the focal position of the cylindrical lens and the slit only in the direction in which the cylindrical lens mainly has a refractive power. Therefore, the manufacture of the optical device can be simplified.
[6] The optical device according to any one of [1] to [5] above may further include a wiring board on which the electro-optic crystal body is mounted. The wiring board includes a plurality of terminals that are electrically connected to the plurality of electric field generators, respectively, and that supply a drive voltage for generating the electric fields to the plurality of electric field generators, respectively. In this case, a drive voltage can be easily supplied to the plurality of electric field generators through the wiring board.
[7] In the optical device according to any one of [1] to [6] above, the electro-optic crystal body may include a KTN crystal.
[8] An optical apparatus according to the present disclosure may include the optical device according to any one of [1] to [7] above and a spatial light modulator of a liquid crystal type. The spatial light modulator may have a plurality of pixels, and may be configured to receive the second parallel beam output from the second lens array of the optical device and to modulate a phase of the second parallel beam for each pixel. The spatial light modulator may have a plurality of modulation regions corresponding to the plurality of electric field generators of the optical device, respectively. According to the optical apparatus, the switching of a modulation pattern can be accelerated while sacrificing resolution.
[9] The optical apparatus according to [8] above may further include a controller that controls the states of the electric fields of the plurality of electric field generators and a modulation pattern of the spatial light modulator. The controller may control the plurality of electric field generators such that the second parallel beam is sequentially incident on the plurality of modulation regions, and update the modulation pattern after the second parallel beam has been completely incident on the plurality of modulation regions.

### Advantageous Effects of Invention

According to the present disclosure, it is possible to provide the optical device capable of switching the disposition pattern of the parallel beam in a plane perpendicular to the optical axis at high speed and freely, and the optical apparatus capable of accelerating the switching of the modulation pattern.

### BRIEF DESCRIPTION OF DRAWINGS

FIG. 1 is a cross-sectional view showing a configuration of an optical device according to a first embodiment of the present disclosure.

FIG. 2 is an enlarged perspective view of an electro-optic crystal body and a plurality of electric field generators.

FIG. 3 is a schematic view showing a state inside the electro-optic crystal body.

FIG. 4 is a schematic view showing examples of switching of a second parallel beam.

FIG. 5 is a perspective view showing an example of a system for supplying a voltage to a first transparent electrode and a second transparent electrode.

FIG. 6 is a perspective view showing another example of a system for supplying a voltage to the first transparent electrode and the second transparent electrode.

FIG. 7 is a view schematically showing a configuration of an optical apparatus according to a second embodiment of the present disclosure.

FIG. 8 is a view schematically showing a configuration of an optical apparatus according to a third embodiment of the present disclosure.

FIG. 9 is a view showing a light modulation surface of a spatial light modulator.

FIG. 10 is a flowchart showing the operation of an optical apparatus.

FIG. 11 is a timing chart showing an example of the operation of the optical apparatus.

FIG. 12 is a view schematically showing a configuration of an optical apparatus according to a fourth embodiment of the present disclosure.

FIG. 13 is a schematic view showing the state inside the electro-optic crystal body in a mode in which both the first transparent electrode and the second transparent electrode include a periodic structure (a) when no electric field is generated and (b) when electric fields are generated.

### DESCRIPTION OF EMBODIMENTS

Hereinafter, embodiments of an optical device and an optical apparatus according to the present disclosure will be described in detail with reference to the accompanying drawings. In the description of the drawings, the same elements are denoted by the same reference signs, and duplicate descriptions will be omitted.

### First Embodiment

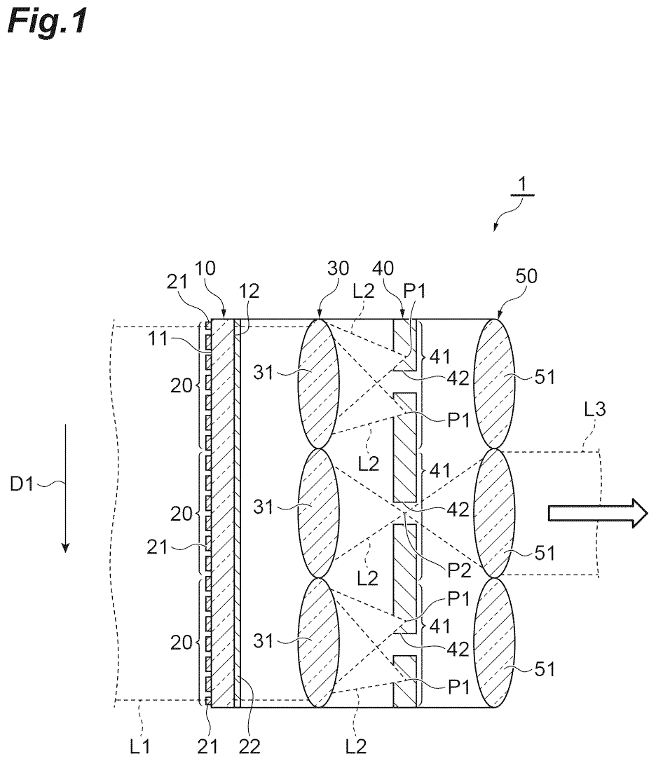

FIG. 1 is a cross-sectional view showing a configuration of an optical device 1 according to a first embodiment of the present disclosure. As shown in FIG. 1, the optical device 1 of the present embodiment includes an electro-optic crystal body 10 having a plate shape, a plurality of electric field generators 20, a first lens array 30, a light shielding member 40, and a second lens array 50.

The electro-optic crystal body 10 includes, for example, at least one crystal selected from KTN crystal, potassium niobate, lithium niobate, potassium tantalate, lithium tantalate, potassium dihydrogen phosphate, dipotassium phosphate, and barium titanate. The KTN crystal is a mixed crystal of potassium niobate and potassium tantalate, and exhibits the optical Kerr effect as an electro-optic effect. In one example, the electro-optic crystal body 10 is composed of a KTN crystal. The electro-optic crystal body 10 has a main surface 11 and a back surface 12. In one example, the main surface 11 and the back surface 12 are parallel to each other. A thickness direction of the electro-optic crystal body 10 coincides with a normal direction of the main surface 11 and the back surface 12. The electro-optic crystal body 10 receives a first parallel beam L1, which has an optical axis along a normal direction of the main surface 11, on the main surface 11. The first parallel beam L1 is, for example, a laser beam output from a laser diode, an SLD (Super Luminescent Diode), or a solid-state laser. A wavelength of the first parallel beam L1 is, for example, 300 nm or more and 3000 nm or less. The first parallel beam L1 transmits through the electro-optic crystal body 10 in the thickness direction of the electro-optic crystal body 10. The electro-optic crystal body 10 outputs the first parallel beam L1, which has transmitted therethrough, from the back surface 12. In order to maximize the transmittance of the first parallel beam L1, the main surface 11 and the back surface 12 are polished.

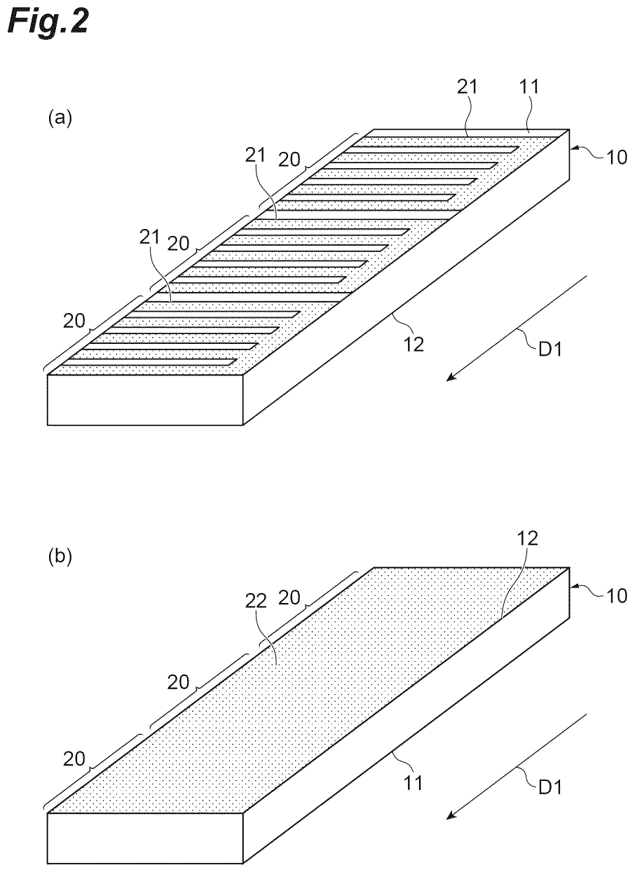

The plurality of electric field generators 20 are disposed side by side in a one-dimensional or two-dimensional manner in a plane along the main surface 11 and/or the back surface 12. FIG. 1 shows an example in which three electric field generators 20 are arranged in one row; however, the number of the electric field generators 20 and the number of rows are not limited thereto. The plurality of electric field generators 20 generate electric fields, the strength of which changes cyclically in a direction D1 along the main surface 11 and/or the back surface 12 of the electro-optic crystal body 10, inside the electro-optic crystal body 10. The plurality of electric field generators 20 are configured to be able to independently control the states of the electric fields.
(a) and (b) in FIG. 2 are enlarged perspective views showing the electro-optic crystal body 10 and the plurality of electric field generators 20. (a) in FIG. 2 is a perspective view of the electro-optic crystal body 10 when viewed from a main surface 11 side, and (b) in FIG. 2 is a perspective view of the electro-optic crystal body 10 when viewed from a back surface 12 side. As shown in (b) of FIG. 2, a plurality of (three in the illustrated example) first transparent electrodes 21 are provided on the main surface 11 of the electro-optic crystal body 10. In the figure, regions where the first transparent electrodes 21 exist are indicated by halftone dots. As shown in (b) of FIG. 2, a second transparent electrode 22 is provided over the entirety of the back surface 12 of the electro-optic crystal body 10. In the figure, a region where the second transparent electrode 22 exists is indicated by halftone dots. The constituent material of the first transparent electrodes 21 and the second transparent electrode 22 is, for example, indium oxide doped with tin such as tin oxide, or tin oxide doped with fluorine. The first transparent electrodes 21 and the second transparent electrode 22 are formed on the surfaces of the electro-optic crystal body 10, for example, by vacuum evaporation.

Each of the plurality of first transparent electrodes 21 includes a structure that is periodic in the direction D1. The structure that is periodic is, for example, a structure in which regions where a portion of the first transparent electrode 21 exists and regions where a portion of the first transparent electrode 21 does not exist are arranged alternately and cyclically. In one example, the first transparent electrodes 21 have a comb shape in which a plurality of comb teeth are arranged in the direction D1.

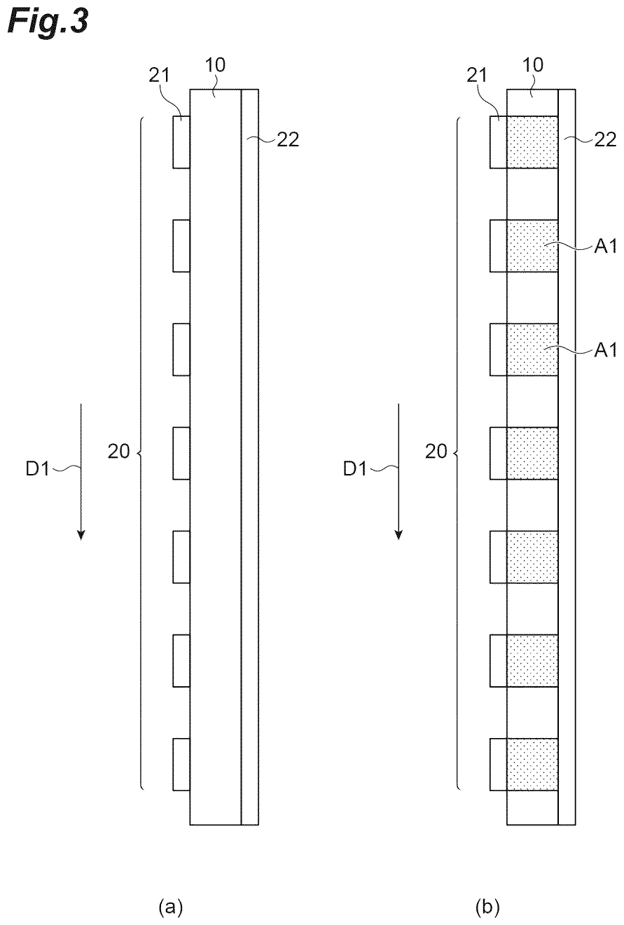

Each of the plurality of electric field generators 20 is composed of one first transparent electrode 21 and a region of the second transparent electrode 22 facing the first transparent electrode 21. The electro-optic crystal body 10 has the optical Kerr effect that is a second-order electro-optic effect. When a voltage is applied between one first transparent electrode 21 and the second transparent electrode 22, electric fields corresponding to the magnitude of the voltage are generated in portions of the electro-optic crystal body 10 therebetween. (a) in FIG. 3 is a schematic view showing the state inside the electro-optic crystal body 10 when no electric field is generated. (b) in FIG. 3 is a schematic view showing the state inside the electro-optic crystal body 10 when electric fields are generated. As shown in (a) of FIG. 3, when no electric field is generated between the first transparent electrode 21 and the second transparent electrode 22, the refractive index distribution inside the electro-optic crystal body 10 is uniform in the direction D1. In contrast, as shown in (b) of FIG. 3, when electric fields are generated between the first transparent electrode 21 and the second transparent electrode 22, the refractive index of regions A1 inside the electro-optic crystal body 10 where the electric fields are generated changes instantaneously with respect to other regions. As a result, the refractive index changes cyclically and instantaneously along the direction D1 in regions inside the electro-optic crystal body 10 corresponding to the electric field generator 20. Accordingly, a diffraction grating with a binary refractive index distribution is formed.

Referring again to FIG. 1, the first lens array 30 is a microlens array. The first lens array 30 is disposed to face the back surface 12 of the electro-optic crystal body 10. An optical axis of the first lens array 30 is parallel to the optical axis of the first parallel beam L1. The first lens array 30 includes a plurality of (three in the illustrated example) first lenses 31. The plurality of first lenses 31 correspond to the plurality of electric field generators 20, respectively. The first lens array 30 focuses the first parallel beam L1, which is output from the back surface 12 of the electro-optic crystal body 10, using each of the plurality of first lenses 31. Each of the plurality of first lenses 31 is, for example, a convex lens. Each of the plurality of first lenses 31 may be a cylindrical lens having a refractive power mainly in the direction of the periodic structure of the first transparent electrode 21 (in the illustrated example, in the direction D1).

When the first parallel beam L1 passes through regions of the electro-optic crystal body 10 where a periodic change in the refractive index occurs, the phase distribution of the first parallel beam L1 changes. Therefore, when the first parallel beam L1 is focused by the first lenses 31, beams L2 after passing through the first lenses 31 are focused at a plurality of focal points P1 separated from each other in the direction of the periodic structure of the first transparent electrodes 21 (in the illustrated example, in the direction D1). In contrast, even when the first parallel beam L1 passes through regions of the electro-optic crystal body 10 where no periodic change in the refractive index occurs, no change occurs in the phase distribution of the first parallel beam L1. Therefore, when the first parallel beam L1 is focused by the first lens 31, the beam L2 after passing through the first lens 31 is focused at the single focal point P2. In the illustrated example, among three electric field generators 20 arranged along the direction D1, only two electric field generators 20 located at both ends generate electric fields, and the electric field generator 20 located at the center does not generate an electric field. When the first lenses 31 are cylindrical lenses, the focal points P1 and P2 have a shape extending linearly along an extending direction of the cylindrical lenses. In other words, the extending direction of the cylindrical lenses is a direction intersecting both the direction of the periodic structure of the first transparent electrodes 21 and an optical axis direction of the first parallel beam L1.

The light shielding member 40 is disposed to face the back surface 12 of the electro-optic crystal body 10 with the first lens array 30 interposed therebetween. The light shielding member 40 is, for example, a metal mask. The light shielding member 40 has a plurality of regions 41 corresponding to the plurality of electric field generators 20, respectively. The plurality of regions 41 correspond to the plurality of first lenses 31, respectively, and are optically coupled to the plurality of first lenses 31, respectively. The light shielding member 40 is configured to allow the beam L2, which is focused by each of the plurality of first lenses 31, to pass through the light shielding member 40 or to shield the beam L2 in each of plurality of regions 41 depending on the state of the electric field of the corresponding electric field generator 20.

In the illustrated example, each of the regions 41 of the light shielding member 40 shields the beam L2 when the beam L2 is focused at the plurality of focal points P1 separated from each other, in other words, when the electric field of the corresponding electric field generator 20 is in an ON state. Each of the regions 41 of the light shielding member 40 allows the beam L2 to pass therethrough when the beam L2 is focused at the single focal point P2, in other words, when the electric field of the corresponding electric field generator 20 is in an OFF state. Therefore, each of the regions 41 of the light shielding member 40 in the illustrated example has a single optical aperture 42 corresponding to the single focal point P2. When the beam L2 is focused at the single focal point P2, the beam L2 passes through the optical aperture 42. When the beam L2 is focused at the plurality of focal points P1 separated from each other, the beam L2 is shielded by the light shielding member 40 outside the optical apertures 42. The optical apertures 42 may be apertures formed in the light shielding member 40, and may be made of a transparent material such as glass. Alternatively, the light shielding member 40 may be configured by providing a light shielding film on a region of a surface of a transparent plate such as glass, except for the optical apertures 42. When the first lens 31 is a cylindrical lens, the optical aperture 42 may be a slit extending along an extending direction of the cylindrical lens. When the wavelength of the first parallel beam L1 is λ and the period of the electric fields generated by the electric field generators 20 is X, a width of the optical apertures 42 is, for example, (λF)/X. However, in practice, the width of the optical apertures 42 may be different from (λF)/X due to the influence of the light intensity distribution and mode of the first parallel beam L1.

In another example, each of the regions 41 of the light shielding member 40 may allow the beam L2 to pass therethrough when the beam L2 is focused at each of the plurality of focal points P1 separated from each other, and shield the beam L2 when the beam L2 is focused at the single focal point P2. In this case, the regions 41 of the light shielding member 40 have optical apertures corresponding to the plurality of focal points P1. In this case, the configuration of the optical apertures may be the same as that of the optical apertures 42 described above.

The second lens array 50 is a microlens array, and is disposed to face a surface of the light shielding member 40 opposite to a surface of the light shielding member 40 facing the first lens array 30. In other words, the light shielding member 40 is disposed between the first lens array 30 and the second lens array 50. An optical axis of the second lens array 50 is parallel to optical axes of the beams L2. The second lens array 50 includes a plurality of (three in the illustrated example) second lenses 51. The plurality of second lenses 51 correspond to the plurality of regions 41 of the light shielding member 40, respectively, and are optically coupled to the optical apertures 42 of the plurality of regions 41, respectively. The second lens array 50 converts the beam L2, which has passed through the light shielding member 40, into a second parallel beam L3 using each of the plurality of second lenses 51. Of the beam L2 focused by the first lens array 30, the beam L2 that has passed through the light shielding member 40 is converted into the second parallel beam L3 by the corresponding second lens 51, and is output to the outside of the optical device 1. Each of the plurality of second lenses 51 is, for example, a convex lens. When each of the plurality of first lenses 31 is a cylindrical lens, each of the plurality of second lenses 51 is also a cylindrical lens having a refractive power mainly in the direction of the periodic structure of the first transparent electrode 21 (in the illustrated example, in the direction D1).

Each distance between the electro-optic crystal body 10, the first lens array 30, the light shielding member 40, and the second lens array 50 may be equal to or different from the focal length of the first lens array 30 and the second lens array 50.

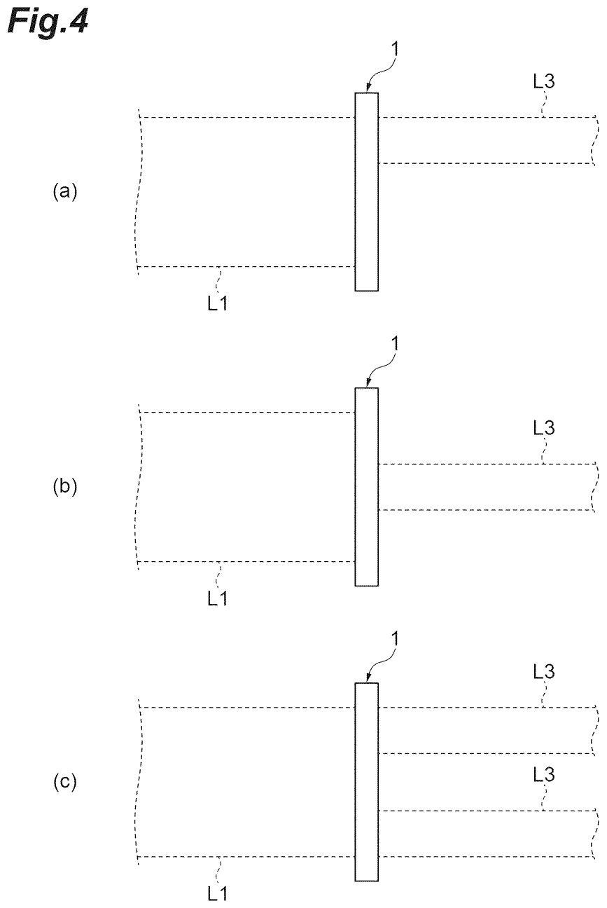

According to the optical device 1 of the present embodiment described above, whether each of the plurality of electric field generators 20 generates an electric field inside the electro-optic crystal body 10 is independently controlled for each of the electric field generators 20. Accordingly, whether a plurality of portions of the first parallel beam L1 corresponding to the plurality of electric field generators 20, respectively, pass through the light shielding member 40 can be freely determined for each portion. Furthermore, the disposition pattern of the second parallel beam L3 in a plane perpendicular to the optical axis can be freely switched at high speed, for example, on the order of kHz by switching the electric field generators 20 that generate electric fields.
(a), (b), and (c) in FIG. 4 are schematic views showing examples of switching of the second parallel beam L3. (a) in FIG. 4 shows the emission position of the second parallel beam L3 when the beam L2 passes through only the region 41 located at an extreme end among three regions 41 shown in FIG. 1 and the beam L2 is shielded in the other two regions 41. (b) in FIG. 4 shows the emission position of the second parallel beam L3 when the beam L2 passes through only the region 41 located at the center among the three regions 41 shown in FIG. 1 and the beam L2 is shielded in the other two regions 41. (c) of FIG. 4 shows the emission position of the second parallel beam L3 when the beam L2 is shielded only in the region 41 located at the center among the three regions 41 shown in FIG. 1 and the beam L2 passes through the other two regions 41. The present invention is not limited to these examples, and the beam L2 may pass through all of the plurality of regions 41. In such a manner, according to the optical device 1 of the present embodiment, the disposition pattern of the second parallel beam L3 in a plane perpendicular to the optical axis can be freely switched.

When the number of the electric field generators 20 is three as in the illustrated example, a total of seven disposition patterns including three disposition patterns in which the second parallel beam L3 passes through only one region 41, three disposition patterns in which the second parallel beam L3 passes through two regions 41, and one disposition pattern in which the second parallel beam L3 passes through all the regions 41 can be realized. When the number of the electric field generators 20 is m, the number of disposition patterns that can be realized is expressed by the following Equation (1).

$$\begin{matrix}[ Equation 1 ] & \\ {\sum }_{k = 1}^{m} ( {}_{m} {C}_{k} ) & ( 1 )\end{matrix}$$

As in the present embodiment, each of the plurality of electric field generators 20 may include the first transparent electrode 21 provided on the main surface 11 and the second transparent electrode 22 provided on the back surface 12. One or both of the first transparent electrode 21 and the second transparent electrode 22 may include a periodic structure. In this case, a configuration in which the first parallel beam L1 passes through the electro-optic crystal body 10 while periodic electric fields are generated inside the electro-optic crystal body 10 can be simply realized.

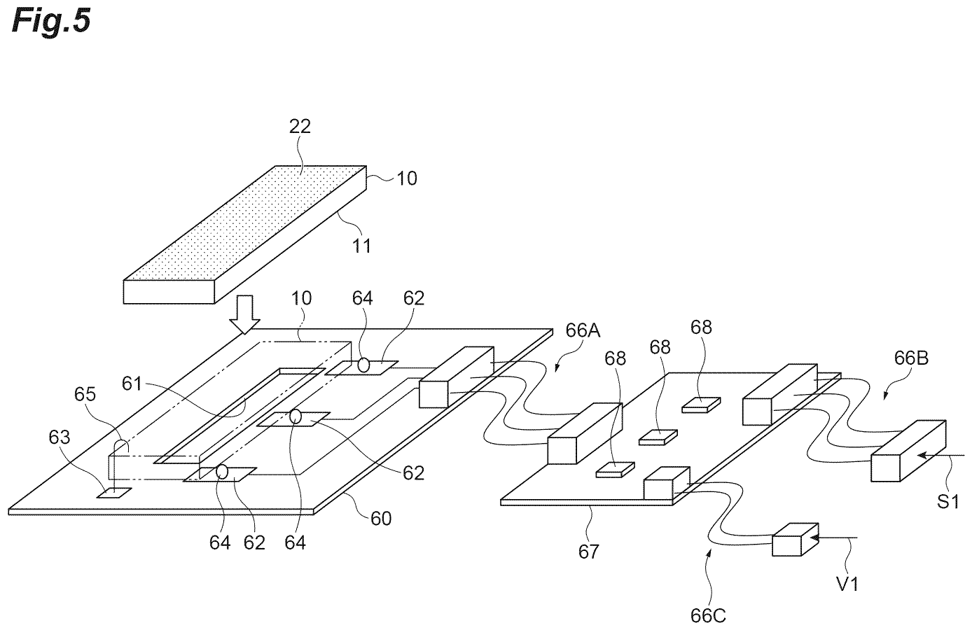

As in the present embodiment, one or both of the first transparent electrode 21 and the second transparent electrode 22 may have a comb shape. In this case, the number of connecting points between the first transparent electrode 21 and/or the second transparent electrode 22 including a periodic structure and wirings (for example, terminals 62 shown in FIG. 5) for applying a voltage to these transparent electrodes can be reduced. Therefore, the structure for applying a voltage to the transparent electrodes can be simplified.

As in the present embodiment, each of the plurality of regions 41 of the light shielding member 40 may be configured to allow the beam L2, which is focused by each of the plurality of first lenses 31, to pass therethrough when the electric field of the corresponding electric field generator 20 is in an OFF state, and to shield the beam L2 when the electric field of the corresponding electric field generator 20 is in an ON state. When the electric field of the electric field generator 20 is in an ON state, a periodic refractive index distribution occurs inside the electro-optic crystal body 10, and the phase distribution of the first parallel beam L1 changes. When the beam L2 obtained by focusing the first parallel beam L1 passes through the light shielding member 40, the phase distribution thereof also remains in the second parallel beam L3, and optical elements disposed downstream of the optical device 1 are affected by the phase distribution. In contrast, when the electric field of the electric field generator 20 is in an OFF state, the refractive index distribution inside the electro-optic crystal body 10 does not change, and the phase distribution of the first parallel beam L1 does not change. Therefore, by configuring each of the plurality of regions 41 of the light shielding member 40 so as to allow the beam L2, which is focused by the first lens 31, to pass therethrough when the electric field of the electric field generator 20 is in an OFF state, the influence on the optical elements disposed downstream of the optical device 1 can be reduced.

As described above, each of the plurality of first lenses 31 may be a cylindrical lens having a refractive power mainly in the direction in which the strength of the electric fields changes cyclically. Each of the plurality of regions 41 may include a slit extending along the extending direction of the cylindrical lens. In this case, it is sufficient to perform alignment between the focal position of the cylindrical lens and the slit only in the direction in which the cylindrical lens mainly has a refractive power. Therefore, the manufacture of the optical device 1 can be simplified.

A device having the same function as the optical device 1 of the present embodiment is an acoustic optic deflector (AOD) that is an acousto-optic device. However, in the acoustic optic deflector (AOD), since the optical system becomes complicated and the optical axis changes, a high level of adjustment technique is required. In the optical device 1 of the present embodiment, it is sufficient to dispose the main surface 11 of the electro-optic crystal body 10 so as to be perpendicular to the optical axis of the first parallel beam L1, and the optical axis does not change. Therefore, the optical device 1 is useful in combination with other devices, for example, a spatial light modulator.

Here, FIG. 5 is a perspective view showing an example of a system for supplying a voltage to the first transparent electrodes 21 and the second transparent electrode 22. As shown in FIG. 5, the optical device 1 may further include a wiring board 60 on which the electro-optic crystal body 10 is mounted. In the illustrated example, the wiring board 60 faces the main surface 11 of the electro-optic crystal body 10. For simplicity, the first lens array 30, the light shielding member 40, and the second lens array 50 are not illustrated in FIG. 5.

The wiring board 60 includes an optical aperture 61, and a plurality of the terminals 62, and a terminal 63. The optical aperture 61 is formed at a position facing the electro-optic crystal body 10, and allows the first parallel beam L1 to pass therethrough. The optical aperture 61 may be an aperture formed in the wiring board 60, and may be made of a transparent material such as glass. Alternatively, the wiring board 60 itself may be made of a transparent material such as glass. In that case, the optical aperture 61 is not required. The plurality of terminals 62 are electrically connected to the plurality of first transparent electrodes 21, respectively. In the illustrated example, the plurality of terminals 62 are conductively joined to the plurality of first transparent electrodes 21 by a conductive paste 64, respectively. Instead of the conductive paste 64, a conductive adhesive material such as solder may be used. The plurality of terminals 62 supply a drive voltage to the plurality of first transparent electrodes 21, respectively. The terminal 63 is electrically connected to the second transparent electrode 22. In the illustrated example, the terminal 63 is electrically connected to the second transparent electrode 22 via a bonding wire 65. The terminal 63 is set to, for example, a reference potential (ground potential).

The wiring board 60 is connected to another wiring board 67 via a wiring 66A with a connector. A plurality of switching elements 68 corresponding to the plurality of electric field generators 20, respectively, are mounted on the wiring board 67. An I/O connection terminal of a computer is connected to the wiring board 67 via a wiring 66B with a connector. A signal S1 that controls the operation of the plurality of switching elements 68 is input from the computer. A DC power supply is connected to the wiring board 67 via a wiring 66C with a connector. A DC power supply voltage V1 to be applied to the plurality of electric field generators 20 is supplied from the DC power supply. Each of the switching elements 68 is connected to the corresponding terminal 62 via the wiring 66A with a connector. Each of the switching elements 68 supplies the DC power supply voltage V1 to the corresponding terminal 62 upon receiving the signal S1 from the computer. The DC power supply voltage V1 is applied to the first transparent electrodes 21 connected to the terminals 62.

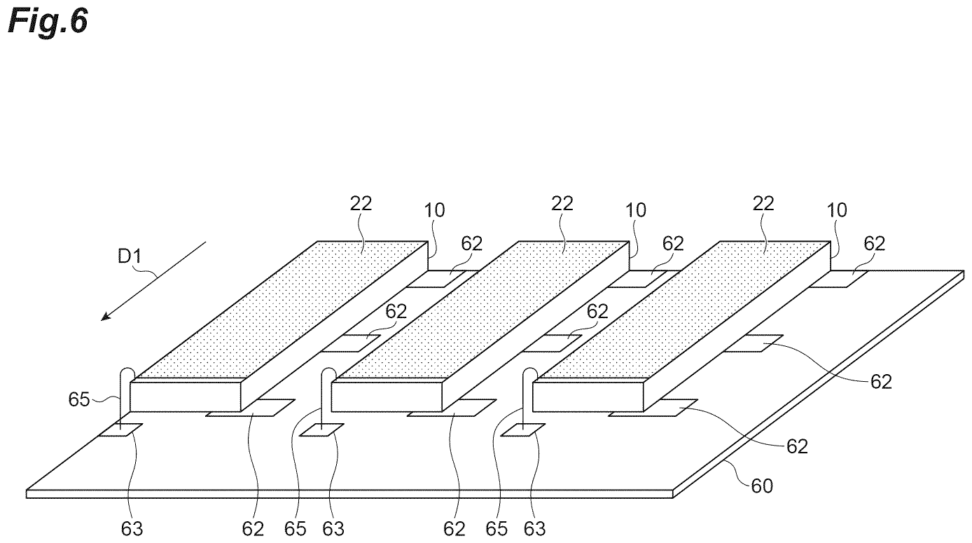

In the example shown in FIG. 5, the single electro-optic crystal body 10 is mounted on the wiring board 60; however, the present invention is not limited to this example. For example, as shown in FIG. 6, a plurality of the electro-optic crystal bodies 10 may be mounted on the wiring board 60. In this case, by arranging the plurality of electro-optic crystal bodies 10 in a direction intersecting an arrangement direction (direction D1) of the plurality of electric field generators 20 in each of the electro-optic crystal bodies 10, a plurality of the electric field generators 20 can be arranged in a two-dimensional manner.

As described above, the optical device 1 may further include the wiring board 60 on which the electro-optic crystal body 10 is mounted. In this case, a drive voltage can be easily supplied to the plurality of electric field generators 20 through the wiring board 60.

### Second Embodiment

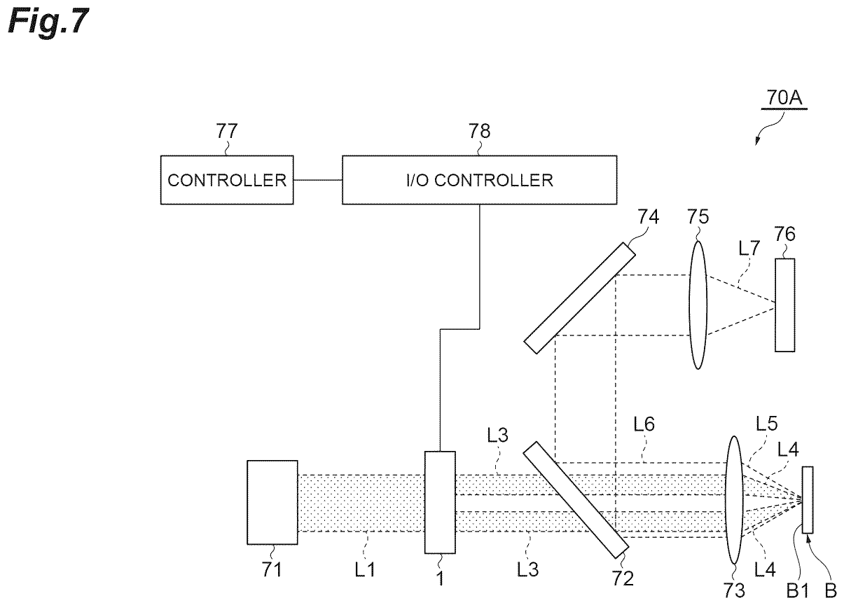

FIG. 7 is a view schematically showing a configuration of an optical apparatus 70A according to a second embodiment of the present disclosure. The optical apparatus 70A of the present embodiment includes the optical device 1 of the first embodiment, a light source 71, a mirror 72, an objective lens 73, a mirror 74, a condenser lens 75, an imager 76, a controller 77, and an I/O controller 78.

The optical device 1 is optically coupled to the light source 71, and receives the first parallel beam L1 from the light source 71. The light source 71 includes, for example, a laser diode, an SLD, or a solid-state laser. The mirror 72 is, for example, a half mirror or a dielectric mirror. The mirror 72 transmits the second parallel beam L3 output from the optical device 1. The objective lens 73 focuses the second parallel beam L3, which has transmitted through the mirror 72, toward an irradiation target surface B1 of an object B. The irradiation target surface B1 receives a beam L4 focused by the objective lens 73, and generates a light L5. For example, the light L5 is a scattered light on the irradiation target surface B1. Alternatively, when the second parallel beam L3 and the beam L4 are excitation light, the light L5 is a fluorescent light output from the object B that is excited. The light L5 is converted into a parallel beam L6 by the objective lens 73. The parallel beam L6 is separated from the second parallel beam L3 by being reflected by the mirror 72. The parallel beam L6 is reflected by the mirror 74, and then is focused toward the imager 76 by the condenser lens 75. The imager 76 captures an image of a beam L7 focused by the condenser lens 75, and generates imaging data.

In the illustrated example, two second parallel beams L3 are focused and the irradiation target surface B1 is irradiated with the two second parallel beams L3. In this case, on surfaces other than the irradiation target surface B1 that is a focusing surface, interference fringes are formed by interference of two beams L4. The interference fringes can be utilized as structured illumination. Alternatively, three second parallel beams L3 that are not arranged in one row may be focused, and the irradiation target surface B1 may be irradiated with the three second parallel beams L3. In this case, three beams L4 interfere with each other to form a grid pattern of light spots. The grid pattern of light spots may be utilized as structured illumination.

The I/O controller 78 is electrically connected to the optical device 1, and applies a drive voltage to the plurality of electric field generators 20 of the optical device 1. The I/O controller 78 is electrically connected to the controller 77, and is controlled by the controller 77. The I/O controller 78 includes, for example, the wiring board 67 and a plurality of the switching elements 68 shown in FIG. 5. The controller 77 provides, for example, the signal S1 shown in FIG. 5 to the I/O controller 78. The controller 77 is a computer such as a personal computer, a smart device such as a smartphone or a tablet terminal, or a cloud server. The computer serving as the controller 77 includes an HDD (Hard Disk Drive), a storage device such as a flash memory or a RAM (random access memory), and a processor (CPU: central processing unit). The controller 77 may be configured as a microcomputer or a field-programmable gate array (FPGA).

According to the optical apparatus 70A of the present embodiment, the optical device 1 is included, so that the disposition pattern of the second parallel beam L3 in a plane perpendicular to the optical axis can be switched at high speed and freely. Therefore, the shape of the irradiation region of the beam L4 with which the irradiation target surface B1 is irradiated can be switched at high speed and freely.

### Third Embodiment

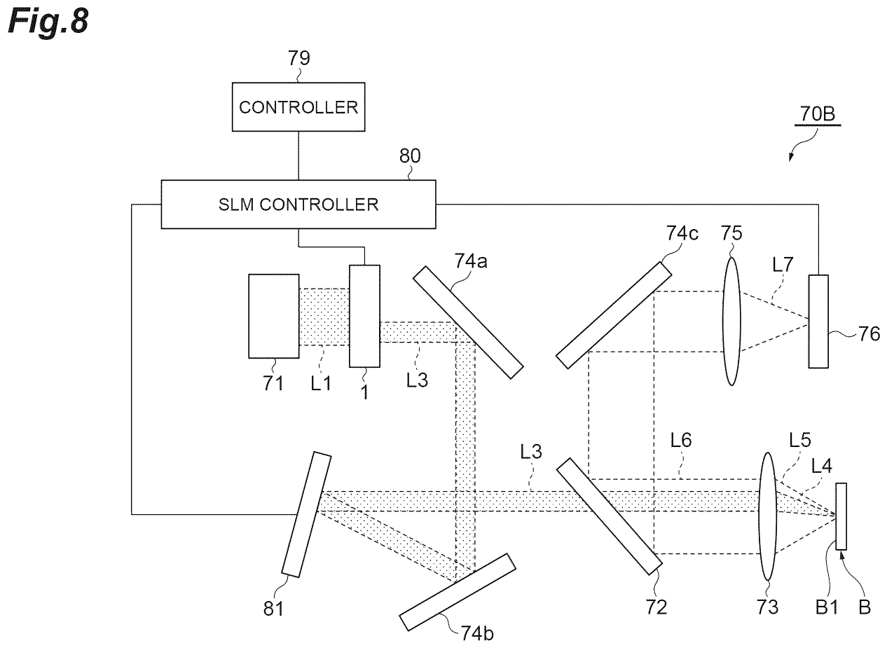

FIG. 8 is a view schematically showing a configuration of an optical apparatus 70B according to a third embodiment of the present disclosure. The optical apparatus 70B of the present embodiment includes the optical device 1 of the first embodiment, the light source 71, the mirror 72, the objective lens 73, mirrors 74a, 74b, and 74c, the condenser lens 75, the imager 76, a controller 79, an SLM controller 80, and a spatial light modulator (SLM) 81.

The first parallel beam L1 output from the light source 71 is a coherent laser beam, the phase of which the phase is spatially aligned. The optical device 1 is optically coupled to the light source 71, and receives the first parallel beam L1 from the light source 71. The mirrors 74a and 74b guides the second parallel beam L3, which is output from the optical device 1, to the SLM 81 by reflecting the second parallel beam L3. The SLM 81 is a liquid crystal SLM. The SLM 81 has a plurality of pixels, receives the second parallel beam L3, and modulates the phase of the second parallel beam L3 for each pixel. The SLM 81 may be of a reflective type or a transmissive type. The mirror 72 is, for example, a half mirror or a dielectric mirror, and transmits the modulated second parallel beam L3 output from the SLM 81. The objective lens 73 focuses the second parallel beam L3, which has transmitted through the mirror 72, toward the irradiation target surface B1 of the object B. The irradiation target surface B1 receives the beam L4 focused by the objective lens 73, and generates the light L5. Alternatively, when the second parallel beam L3 and the beam L4 are excitation light, the light L5 is a fluorescent light output from the object B that is excited. The light L5 is converted into the parallel beam L6 by the objective lens 73. The parallel beam L6 is reflected by the mirror 74c, and then is focused toward the imager 76 by the condenser lens 75. The imager 76 captures an image of the beam L7 focused by the condenser lens 75, and generates imaging data.

The SLM controller 80 is electrically connected to the SLM 81, and provides a signal indicating a modulation pattern to the SLM 81. The SLM controller 80 is electrically connected to the optical device 1, and applies a drive voltage to the plurality of electric field generators 20 of the optical device 1. Further, the SLM controller 80 is electrically connected to the imager 76, and provides a trigger signal indicating an imaging timing to the imager 76. The SLM controller 80 is electrically connected to the controller 79, and is controlled by the controller 79. The SLM controller 80 includes, for example, the wiring board 67 and a plurality of the switching elements 68 shown in FIG. 5. The controller 79 controls the states of the electric fields of the plurality of electric field generators 20 and the modulation pattern of the SLM 81. The controller 79 provides, for example, the signal S1 shown in FIG. 5 to the SLM controller 80. The controller 79 is a computer such as a personal computer, a smart device such as a smartphone or a tablet terminal, or a cloud server. The computer serving as the controller 79 includes a HDD, a storage device such as a flash memory or a RAM, and a processor (CPU). The controller 79 may be configured as a microcomputer or a field-programmable gate array (FPGA).

The SLM 81 has a plurality of modulation regions corresponding to the plurality of electric field generators 20 of the optical device 1, respectively. Furthermore, an individual modulation pattern is presented in each modulation region. The modulation pattern may be, for example, a two-beam interference pattern required for structured illumination, or a multi-beam interference pattern showing a grating pattern. In this case, a plurality of (for example, 5×5 or 1×5) light spots distributed in a two-dimensional manner are formed on the irradiation target surface B1. The disposition and number of the light spots that are formed may differ for each modulation region. In such a manner, an individual modulation pattern is presented in each modulation region, so that the irradiation pattern on the irradiation target surface B1 changes in response to switching of the disposition pattern of the second parallel beam L3.

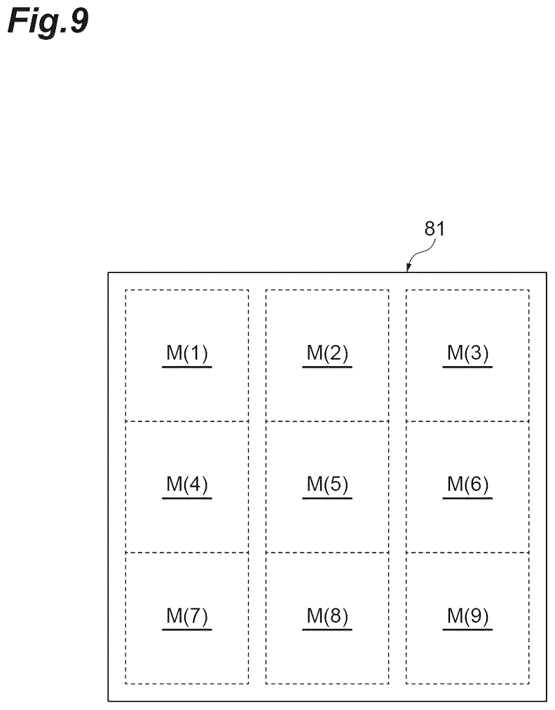

Here, for the sake of description, it is assumed that the optical device 1 includes the electric field generators 20 arranged in three rows and three columns (a total of nine). FIG. 9 is a view showing a light modulation surface of the SLM 81 in this case. As shown in FIG. 9, the SLM 81 has nine modulation regions M(1) to M(9), the number of which is the same as that of the electric field generators 20. Similarly to the electric field generators 20, the modulation regions M(1) to M(9) are arranged in three rows and three columns. The modulation regions M(1) to M(9) correspond one-to-one to the nine electric field generators 20. The second parallel beam L3, which has passed through the corresponding electric field generator 20 and is output from the optical device 1, is incident on and modulated in each of the nine modulation regions M(1) to M(9). The controller 79 causes the second parallel beam L3 to be sequentially incident on and modulated in the modulation regions M(1) to M(9) by controlling an application voltage to the nine electric field generators 20. Then, the controller 79 updates the modulation pattern of the SLM 81 through the SLM controller 80 after the second parallel beam L3 has been completely incident on the modulation regions M(1) to M(9). Thereafter, the controller 79 causes the second parallel beam L3 to be sequentially incident on and modulated in the modulation regions M(1) to M(9) by controlling an application voltage to the nine electric field generators 20 again. The optical apparatus 70B repeats such an operation.

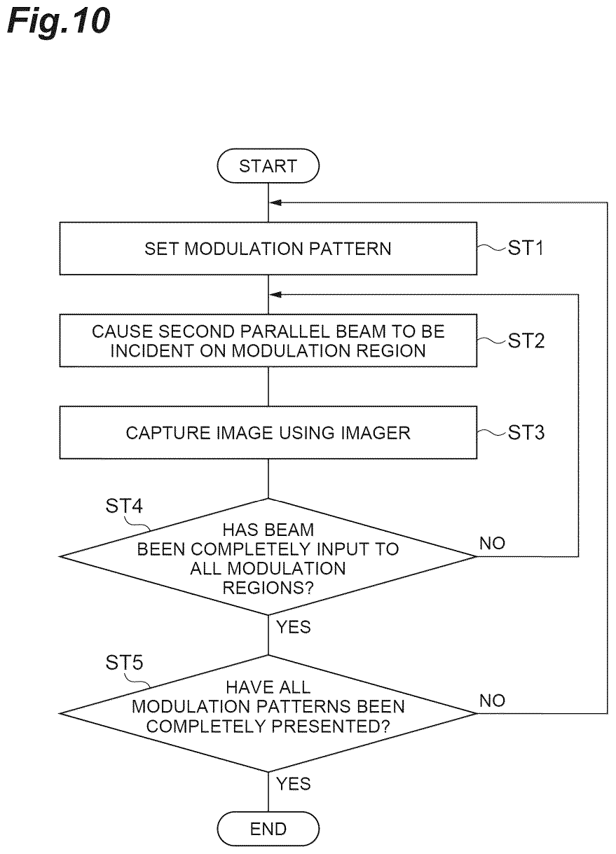

FIG. 10 is a flowchart showing the operation of the optical apparatus 70B. As shown in FIG. 10, first, the controller 79 sets the modulation pattern of the SLM 81 through the SLM controller 80 (step ST1). The modulation pattern includes an individual modulation pattern in each of the plurality of modulation regions M(1) to M(9). Next, the controller 79 causes the second parallel beam L3 to be incident on the modulation region M(1) by controlling the nine electric field generators 20 through the SLM controller 80 (step ST2). Then, the controller 79 provides a trigger signal indicating an imaging timing to the imager 76 through the SLM controller 80. Accordingly, the imager 76 captures an image (step ST3). Thereafter, the process returns to step ST2, the second parallel beam L3 is incident on the modulation region M(2), and step ST3 is performed again. In such a manner, while the second parallel beam L3 is sequentially incident on all the modulation regions M(1) to M(9), step ST3 is performed each time. After the second parallel beam L3 has been completely incident on all the modulation regions M(1) to M(9) (step ST4: YES), the process returns to step ST1, and the modulation pattern of the SLM 81 is updated. The modulation pattern includes an individual modulation pattern in each of the plurality of modulation regions M(1) to M(9). Then, steps ST2 to ST4 are repeated again. After all the modulation patterns that are prepared in advance have been completely presented (step ST5: YES), the optical apparatus 70B ends its operation.

Effects obtained by the optical apparatus 70B of the present embodiment are as follows. In the liquid crystal SLM 81, an electric field is individually formed inside a liquid crystal layer by each of a plurality of electrodes. However, since the response of the liquid crystal to a change over time in the electric field inside the liquid crystal layer is delayed, the switching speed of the modulation patterns is impaired, which is a problem. In the present embodiment, the light modulation surface of the SLM 81 is divided into the plurality of modulation regions M(1) to M(9), and the second parallel beam L3 is sequentially input to each of the plurality of modulation regions M(1) to M(9) using the optical device 1. Accordingly, the switching of the modulation patterns can be accelerated while sacrificing resolution. Accordingly, the optical apparatus 70B can perform holographic light control at a high rate, and can be applied to the observation of high-speed phenomena, or an optical tweezer technology or an atom trapping technology that requires a high frame rate.

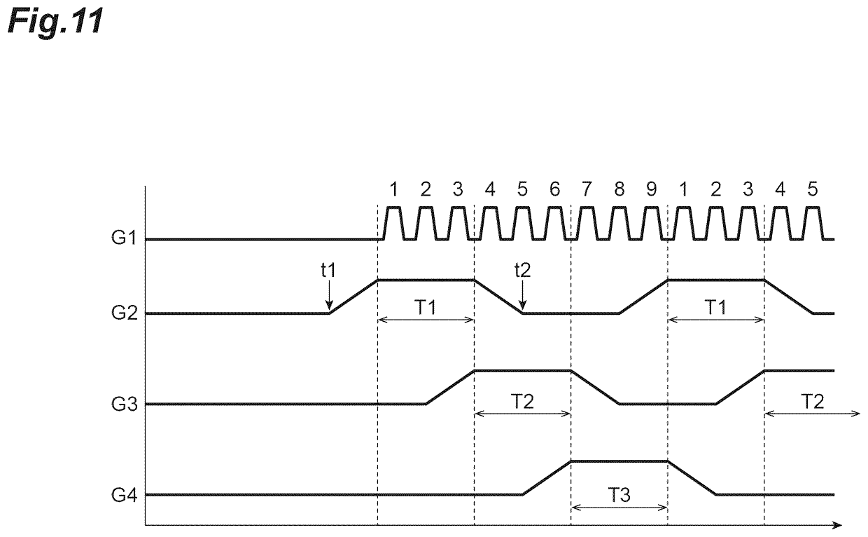

In the above description, after the second parallel beam L3 has been completely incident on all the modulation regions M(1) to M(9), the modulation pattern of the SLM 81 is updated. The present invention is not limited to this example, and the modulation pattern of the SLM 81 may be divided into two or more regions (for example, three regions), and the modulation pattern may be updated for each region. FIG. 11 is a timing chart showing an example of such an operation. In FIG. 11, line G1 represents the period during which the second parallel beam L3 is incident on the modulation regions M(1) to M(9). In sections where line G1 is at a high level, the second parallel beam L3 is input to one of the modulation regions. Each number assigned in the vicinity of line G1 represents the number i of the modulation region M(i) on which the second parallel beam L3 is incident. Line G2 represents the period during which the modulation patterns of the modulation regions M(1) to M(3) are presented. In section T1 where line G2 is at a high level, the modulation patterns of the modulation regions M(1) to M(3) are presented. Line G3 represents the period during which the modulation patterns of the modulation regions M(4) to M(6) are presented. In section T2 where line G3 is at a high level, the modulation patterns of the modulation regions M(4) to M(6) are presented. Line G4 represents the period during which the modulation patterns of the modulation regions M(7) to M(9) are presented. In section T3 where line G4 is at a high level, the modulation patterns of the modulation regions M(7) to M(9) are presented.

Since the response of the liquid crystal layer is delayed, for example, when the modulation patterns of the modulation regions M(1) to M(3) in section T1 are presented, the application of a voltage to the electrodes of the modulation regions M(1) to M(3) starts at timing t1 before section T1. Then, after the application of a voltage to the electrodes is ended at the end of section T1, the presentation of the modulation patterns ends completely at timing t2 after section T1. The same applies to when the modulation patterns of the modulation regions M(4) to M(6) are presented in section T2, and when the modulation patterns of the modulation regions M(7) to M(9) are presented in section T3.

In such a manner, the modulation pattern of the SLM 81 is divided into two or more regions, and the modulation pattern is updated for each region. Accordingly, as shown in the timing chart of FIG. 11, the second parallel beam L3 can be repeatedly incident on the modulation regions M(1) to M(9) without being affected by the response time of the liquid crystal layer. Therefore, the switching of the modulation patterns can be further accelerated.

### Fourth Embodiment

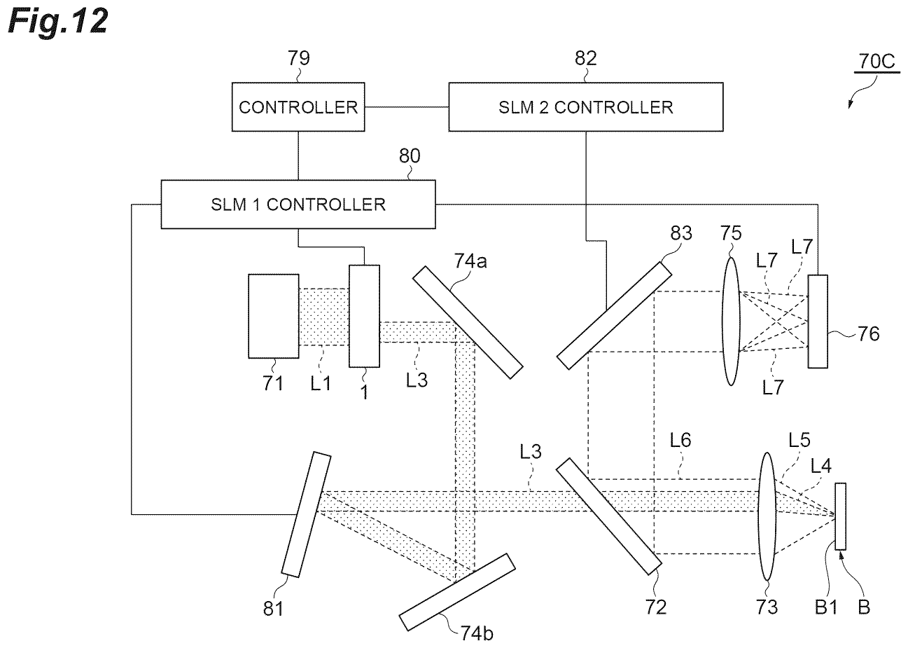

FIG. 12 is a view schematically showing a configuration of an optical apparatus 70C according to a fourth embodiment of the present disclosure. The optical apparatus 70C of the present embodiment further includes an SLM controller 82 and an SLM 83 in addition to the configuration of the optical apparatus 70B of the third embodiment. The imager 76 of the present embodiment employs a rolling shutter system in which beam of a plurality of light incident regions arranged in one direction is sequentially detected.

The SLM controller 82 is electrically connected to the SLM 83, and provides a signal indicating a modulation pattern to the SLM 83. The SLM controller 82 is electrically connected to the controller 79, and is controlled by the controller 79. The controller 79 controls the modulation pattern, which is presented to the SLM 83, through the SLM controller 82. The modulation pattern presented to the SLM 83 causes the condenser lens 75 to form focused images of the beam L7 at a plurality of positions. The focused images of the beam L7 at the plurality of positions are the same image. Since the imager 76 employs a rolling shutter system, the imager 76 sequentially captures a plurality of the focused images of the beam L7, which are formed at the plurality of positions, respectively, at an equal time intervals. Accordingly, the focused images of the beam L7 can be captured at a rate faster than the original frame rate of the imager 76.

The optical device and the optical apparatus according to the present disclosure are not limited to each embodiment described above, and can be modified in various modes. For example, in the first embodiment described above, the first transparent electrodes 21 include a structure that is periodic in the direction D1, and the second transparent electrode 22 is formed over the entirety of the back surface 12. The present invention is not limited to this mode, and the first transparent electrode 21 may be formed over the entirety of the main surface 11, and the second transparent electrodes 22 may include a structure that is periodic in the direction D1. In this case, the second transparent electrodes 22 may have a comb shape.

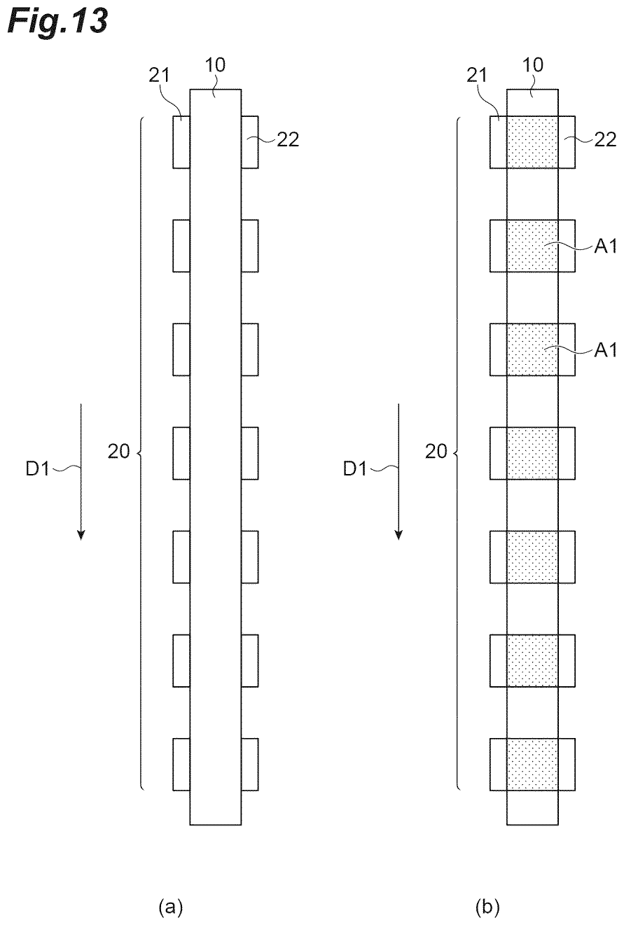

Alternatively, both the first transparent electrodes 21 and the second transparent electrodes 22 may include a structure that is periodic in the direction D1. In this case, both the first transparent electrodes 21 and the second transparent electrodes 22 may have a comb shape. FIG. 13 is a schematic view showing the state inside the electro-optic crystal body 10 in such a mode (a) when no electric field is generated and (b) when electric fields are generated. As shown in (b) of FIG. 13, even in such a mode, when electric fields are generated between the first transparent electrodes 21 and the second transparent electrodes 22, the refractive index of the regions A1 inside the electro-optic crystal body 10 where the electric fields are generated changes instantaneously with respect to other regions. As a result, the refractive index changes cyclically and instantaneously along the direction D1 in regions inside the electro-optic crystal body 10 corresponding to the electric field generator 20. In such a manner, when both the first transparent electrodes 21 and the second transparent electrodes 22 include a structure that is periodic in the direction D1, the spread of the electric fields in the direction D1 can be suppressed compared to when the first transparent electrode 21 or the second transparent electrode 22 is formed over the entirety of the main surface 11 or the back surface 12. Therefore, a periodic refractive index distribution can be formed in a more refined manner.

In the above-described embodiments, the directions of the periods in the periodic structure of the plurality of first transparent electrodes 21 coincide with each other among the plurality of first transparent electrodes 21. The present invention is not limited to this mode, and the direction of the periods in the periodic structure of at least one first transparent electrode 21 may be different from the direction of the periods in the periodic structure of the other first transparent electrodes 21.

In the above-described embodiments, a comb shape has been provided as an example of the shape of the first transparent electrode 21 and/or the second transparent electrode 22. The electric field generator that generates an electric field, the strength of which changes cyclically, inside the electro-optic crystal body 10 is not limited to this form. For example, the electric field generator may include a plurality of transparent electrodes arranged in a two-dimensional manner. In this case, a voltage may be selectively applied to some of the plurality of transparent electrodes such that electric fields, the strength of which changes cyclically, are generated.

In the above-described embodiments, a mode in which the electric field generator is configured as a transparent electrode has been provided as an example; however, the electric field generator may be configured as an opaque electrode, for example, a metal electrode. In this case, it is preferable that the electrode has a structure that allows the first parallel beam L1 to pass therethrough, for example, an opening portion.

### REFERENCE SIGNS LIST

1: optical device, 10: electro-optic crystal body, 11: main surface, 12: back surface, 20: electric field generator, 21: first transparent electrode, 22: second transparent electrode, 30: first lens array, 31: first lens, 40: light shielding member, 41: region, 42: optical aperture, 50: second lens array, 51: second lens, 60: wiring board, 61: optical aperture, 62, 63: terminal, 64: conductive paste, 65: bonding wire, 66A, 66B, 66C: wiring with connector, 67: wiring board, 68: switching element, 70A, 70B, 70C: optical apparatus, 71: light source, 72: mirror, 73: objective lens, 74, 74a, 74b, 74c: mirror, 75: condenser lens, 76: imager, 77, 79: controller, 78: I/O controller, 80, 82: SLM controller, 81, 83: spatial light modulator (SLM), A1: region, B: object, B1: irradiation target surface, D1: direction, L1: first parallel beam, L2, L4, L5, L7: light, L3: second parallel beam, L6: parallel beam, M(1) to M(9), M(i): modulation region, P1, P2: focal point, S1: signal, V1: DC power supply voltage.

1: An optical device, comprising:
an electro-optic crystal body having a plate shape, having a main surface and a back surface, and configured to receive a first parallel beam on the main surface and to output the first parallel beam from the back surface;
a plurality of electric field generators that are disposed side by side in a one-dimensional or two-dimensional manner in a plane along the main surface or the back surface of the electro-optic crystal body, that are respectively configured to generate electric fields, a strength of which changes cyclically in a direction along the main surface or the back surface, inside the electro-optic crystal body, and that are configured to be able to independently control states of the electric fields;
a first lens array including a plurality of first lenses corresponding to the plurality of electric field generators, respectively, and configured to focus the first parallel beam, which is output from the back surface of the electro-optic crystal body, using each of the plurality of first lenses;
a light shielding member having a plurality of regions corresponding to the plurality of electric field generators, respectively, and configured to allow a beam, which is focused by each of the plurality of first lenses, to pass through the light shielding member or to shield the beam in each of the plurality of regions depending on a state of an electric field of a corresponding electric field generator among the plurality of electric field generators; and
a second lens array including a plurality of second lenses corresponding to the plurality of regions, respectively, and configured to convert the beam, which has passed through the light shielding member, into a second parallel beam using each of the plurality of second lenses.

2: The optical device according to claim 1,
wherein each of the plurality of electric field generators includes a first transparent electrode provided on the main surface and configured to transmit the first parallel beam, and a second transparent electrode provided on the back surface, and configured to transmit the first parallel beam and to cooperate with the first transparent electrode to generate the electric fields inside the electro-optic crystal body, and
one or both of the first transparent electrode and the second transparent electrode include a structure that is periodic in the direction.

3: The optical device according to claim 2,
wherein one or both of the first transparent electrode and the second transparent electrode have a comb shape.

4: The optical device according to claim 1,
wherein each of the plurality of regions is configured to allow the beam, which is focused by each of the plurality of first lenses, to pass through each of the plurality of regions when the electric field of the corresponding electric field generator among the plurality of electric field generators is in an OFF state, and to shield the beam when the electric field of the corresponding electric field generator is in an ON state.

5: The optical device according to claim 1,
wherein each of the plurality of first lenses is a cylindrical lens having a refractive power mainly in the direction, and
each of the plurality of regions includes a slit extending along an extending direction of the cylindrical lens.

6: The optical device according to claim 1, further comprising:
a wiring board on which the electro-optic crystal body is mounted,
wherein the wiring board includes a plurality of terminals that are electrically connected to the plurality of electric field generators, respectively, and that supply a drive voltage for generating the electric fields to the plurality of electric field generators, respectively.

7: The optical device according to claim 1,
wherein the electro-optic crystal body includes a KTN crystal.

8: An optical apparatus, comprising:
the optical device according to claim 1; and
a spatial light modulator, being of a liquid crystal type, having a plurality of pixels, and configured to receive the second parallel beam output from the second lens array of the optical device and to modulate a phase of the second parallel beam for each pixel,
wherein the spatial light modulator has a plurality of modulation regions corresponding to the plurality of electric field generators of the optical device, respectively.

9: The optical apparatus according to claim 8, further comprising:
a controller that controls the states of the electric fields of the plurality of electric field generators and a modulation pattern of the spatial light modulator, and
wherein the controller controls the plurality of electric field generators such that the second parallel beam is sequentially incident on the plurality of modulation regions, and updates the modulation pattern after the second parallel beam has been completely incident on the plurality of modulation regions.
